(19) United States
(12) Patent Application Publication
(10) Pub. No.: US 2025/0182767 A1
(43) Pub. Date: Jun. 5, 2025

(54) CONTROL APPARATUS, VEHICLE, CONTROL METHOD, AND NON-TRANSITORY COMPUTER READABLE MEDIUM

(71) Applicant: TOYOTA JIDOSHA KABUSHIKI KAISHA, Toyota-shi Aichi-ken (JP)

(72) Inventors: Eiichi MAEDA, Asaka-shi Saitama-ken (JP); Reona GOMI, Nagoya-shi Aichi-ken (JP); Chikage KUBO, Chofu-shi Tokyo-to (JP); Kaori YAMADA, Nagakute-shi Aichi-ken (JP); Keiko NAKANO, Kawasaki-shi Kanagawa-ken (JP); Masatoshi TERADA, Yamato-shi Kanagawa-ken (JP)

(73) Assignee: TOYOTA JIDOSHA KABUSHIKI KAISHA, Toyota-shi Aichi-ken (JP)

(21) Appl. No.: 18/958,713

(22) Filed: Nov. 25, 2024

(30) Foreign Application Priority Data
Nov. 30, 2023 (JP) 2023-203205

(51) Int. Cl. G10L 17/22; B60R 16/037; G10L 17/02; G10L 17/06

(52) U.S. Cl. CPC G10L 17/22; G10L 17/02; G10L 17/06; B60R 16/0373

(57) ABSTRACT

A control apparatus includes a controller that, upon detecting a first voice having been uttered by a first occupant, among occupants, as a command to activate a function, determines, as a first attribute, an attribute of the first occupant, upon detecting, after the first voice has been detected and before the function is activated, a second voice that is different from the first voice and has been uttered as a command to cancel the activation of the function, determines, as a second attribute, an attribute of a second occupant who has uttered the second voice, and determines, according to the result of a comparison between the first and second attributes, whether to interrupt control to be performed based on the first voice.

### CROSS-REFERENCE TO RELATED APPLICATION

This application claims priority to Japanese Patent Application No. 2023-203205 filed on Nov. 30, 2023, the entire contents of which are incorporated herein by reference.

### TECHNICAL FIELD

The present disclosure relates to a control apparatus, a vehicle, a control method, and a program.

### BACKGROUND

Systems that perform control of in-vehicle devices based on speech of occupants of vehicles are known. Patent Literature (PTL) 1 discloses a vehicle equipment controller that controls equipment mounted on a vehicle on the basis of contents of an instruction acquired by recognizing utterance of an occupant of the vehicle. Patent Literature (PTL) 2 discloses a voice recognition device that controls a control apparatus based on a registered vocabulary when the inputted speech voice from a user is recognized that it matches the registered vocabulary.

### CITATION LIST

### Patent Literature

PTL 1: JP 2020-157944 A
PTL 2: JP 2009-104020 A

### SUMMARY

In systems that perform control of in-vehicle devices based on speech of occupants, there have been known methods of restricting operations based on attributes of speakers, for example, by prohibiting children from controlling any functions dangerous for the children to operate. However, even for functions that seem safe enough for children to operate, operations of such functions may also need to be interrupted and aborted by adults when such operations are merely mischievous or erroneous.

It would be helpful to enable restriction of unintended operations, such as mischievous operations and erroneous operations.

A control apparatus according to the present disclosure is a control apparatus configured to detect, as a command, a voice having been uttered by each of a plurality of occupants in a vehicle, and control, based on the detected voice, a function installed in the vehicle, the control apparatus including:
a controller configured to:
   upon detecting a first voice having been uttered by a first occupant, among the plurality of occupants, the first voice having been uttered as a command to activate the function, determine, as a first attribute, an attribute of the first occupant;
   upon detecting, after the first voice has been detected and before the function is activated, a second voice different from the first voice, the second voice having been uttered as a command to cancel the activation of the function, determine, as a second attribute, an attribute of a second occupant who has uttered the second voice; and
   determine, according to the result of a comparison between the first attribute and the second attribute, whether to interrupt control to be performed based on the first voice.

A control method according to the present disclosure is a control method performed by a control apparatus configured to detect, as a command, a voice having been uttered by each of a plurality of occupants in a vehicle, and control, based on the detected voice, a function installed in the vehicle, the control method including:
detecting, by the control apparatus, a first voice having been uttered by a first occupant, among the plurality of occupants, the first voice having been uttered as a command to activate the function;
determining, by the control apparatus, as a first attribute, an attribute of the first occupant;
detecting, by the control apparatus, after the first voice has been detected and before the function is activated, a second voice different from the first voice, the second voice having been uttered as a command to cancel the activation of the function;
determining, by the control apparatus, as a second attribute, an attribute of a second occupant who has uttered the second voice;
comparing, by the control apparatus, the first attribute with the second attribute; and
determining, by the control apparatus, according to the result of the comparison, whether to interrupt control to be performed based on the first voice.

A program according to the present disclosure is configured to cause a computer, as a control apparatus, to execute operations, the control apparatus being configured to detect, as a command, a voice having been uttered by each of a plurality of occupants in a vehicle, and control, based on the detected voice, a function installed in the vehicle, the operations including:
detecting a first voice having been uttered by a first occupant, among the plurality of occupants, the first voice having been uttered as a command to activate the function;
determining, as a first attribute, an attribute of the first occupant;
upon detecting, after the first voice has been detected and before the function is activated, a second voice different from the first voice, the second voice having been uttered as a command to cancel the activation of the function, determining, as a second attribute, an attribute of a second occupant who has uttered the second voice;
comparing the first attribute with the second attribute; and
determining, according to the result of the comparison, whether to interrupt control to be performed based on the first voice.

The present disclosure enables restriction of unintended operations, such as mischievous operations and erroneous operations.

### BRIEF DESCRIPTION OF THE DRAWINGS

In the accompanying drawings:

FIG. 1 is a diagram illustrating a configuration of a system according to an embodiment of the present disclosure;

FIG. 2 is a block diagram illustrating a configuration of a control apparatus according to the embodiment of the present disclosure;

FIG. 3 is a flowchart illustrating operations of the system according to the embodiment of the present disclosure; and

FIG. 4 is a flowchart illustrating operations of the system according to the embodiment of the present disclosure.

### DETAILED DESCRIPTION

Hereinafter, an embodiment of the present disclosure will be described with reference to the drawings.

In the drawings, the same or corresponding portions are denoted by the same reference numerals. In the descriptions of the present embodiment, detailed descriptions of the same or corresponding portions are omitted or simplified, as appropriate.

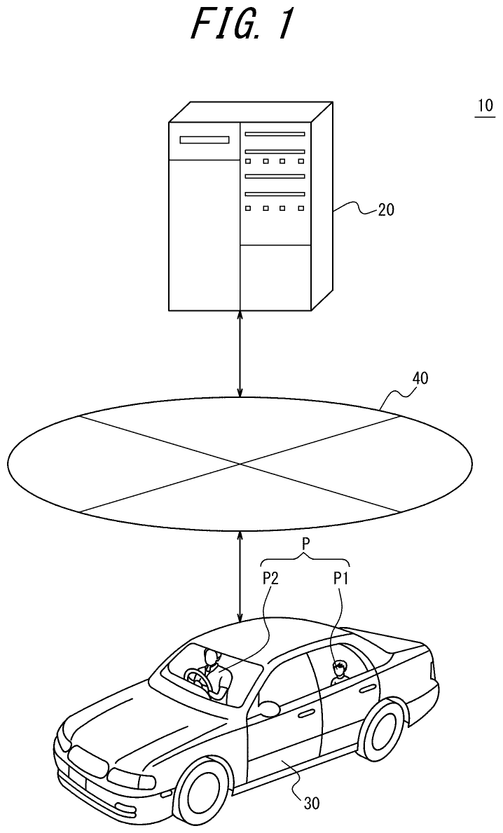

A configuration of a system 10 according to the present embodiment will be described with reference to FIG. 1.

The system 10 includes at least one control apparatus 20 and at least one vehicle 30. The system 10 may include multiple control apparatuses 20 and vehicles 30.

The control apparatus 20 can communicate with the vehicle 30 via a network 40.

The control apparatus 20 is installed in a facility such as a data center. The control apparatus 20 is, for example, a server that belongs to a cloud computing system or another type of computing system.

The vehicle 30 is, for example, any type of automobile such as a gasoline vehicle, a diesel vehicle, a hydrogen vehicle, an HEV, a PHEV, a BEV, or an FCEV. The term “HEV” is an abbreviation of hybrid electric vehicle. The term “PHEV” is an abbreviation of plug-in hybrid electric vehicle. The term “BEV” is an abbreviation of battery electric vehicle. The term “FCEV” is an abbreviation of fuel cell electric vehicle. A plurality of occupants P, including a first occupant P1 and a second occupant P2, are on board in the vehicle 30. The plurality of occupants P may include occupants other than the first and second occupants P1 and P2. The vehicle 30 is a private car in the present embodiment, but is not limited to this. The vehicle 30 may be a taxi, bus, welfare vehicle, or the like, as long as the vehicle 30 can transport the plurality of occupants P and has in-vehicle devices whose functions can be controlled based on speech by the occupants P. The vehicle 30 may be driven by a driver, or an AV the driving of which is automated at any level. The term “AV” is an abbreviation of autonomous vehicle. The automation level is, for example, any one of Level 1 to Level 5 according to the level classification defined by SAE. The name “SAE” is an abbreviation of Society of Automotive Engineers.

The network 40 includes the Internet, at least one WAN, at least one MAN, or a combination thereof. The term “WAN” is an abbreviation of wide area network. The term “MAN” is an abbreviation of metropolitan area network. The network 40 may include at least one wireless network, at least one optical network, or a combination thereof. The wireless network is, for example, an ad hoc network, a cellular network, a wireless LAN, a satellite communication network, or a terrestrial microwave network. The term “LAN” is an abbreviation of local area network.

In FIG. 1, the control apparatus 20 is connected to each vehicle 30 via the network 40, but the control apparatus 20 may be configured as an in-vehicle control apparatus installed in each vehicle 30.

An outline of the present embodiment will be described with reference to FIG. 1.

In general, in a system that controls in-vehicle devices based on speech of occupants of a vehicle, an occupant who wishes to perform voice operations uses an activation word, a talk switch, or the like as a trigger to activate a voice dialogue service called an agent, to thereby perform the voice operations from the occupant's seat. In such a case, it is common that commands from seats other than the seat whose occupant has activated the agent are not recognized. Thus, for example, when a voice operation is performed based on speech of an occupant, another occupant may not be able to cancel the voice operation. For example, even when the voice operation is a mischievous or erroneous operation that has been performed by a child, a parent seated in a different seat from the child cannot cancel the operation. Therefore, there is a risk of unintended control of the in-vehicle devices.

In the system 10 according to the present embodiment, the control apparatus 20 detects, as commands, voices that have been uttered by each of the plurality of occupants P in the vehicle 30, and controls, based on the detected voices, functions F installed in the vehicle 30. In the present embodiment, the functions F include a function f to be realized by any of the in-vehicle devices installed in the vehicle 30. Examples of the in-vehicle devices include an air conditioning device, power doors, lighting devices, seat adjustment mechanisms, an audio device, and the like. The In-vehicle devices may also include, for example, a driver's seat, a steering wheel, side door mirrors, an inner mirror, a head-up display, and other components in the vehicle 30. Upon detecting a first voice V1 that has been uttered by the first occupant P1, among the plurality of occupants P, as a command to activate a function f1, the control apparatus 20 determines, as a first attribute T1, an attribute of the first occupant P1. Upon detecting, after the first voice V1 has been detected and before the function f1 is activated, a second voice V2 that is different from the first voice V1 and has been uttered as a command to cancel the activation of the function f1, the control apparatus 20 determines, as a second attribute T2, an attribute of the second occupant P2 who has uttered the second voice V2. The control apparatus 20 determines, according to the result of a comparison between the first attribute T1 and the second attribute T2, whether to interrupt control to be performed based on the first voice V1.

According to the present embodiment, the control to be performed based on the first voice V1 can be interrupted by the second voice V2 when a predetermined condition is satisfied as the result of the comparison between the attributes T of the occupants P who have uttered the voices as commands. In other words, when a voice operation is performed based on speech of an occupant, another occupant can cancel the voice operation as necessary. As a result, unintended operations such as mischievous or erroneous operations can be restricted.

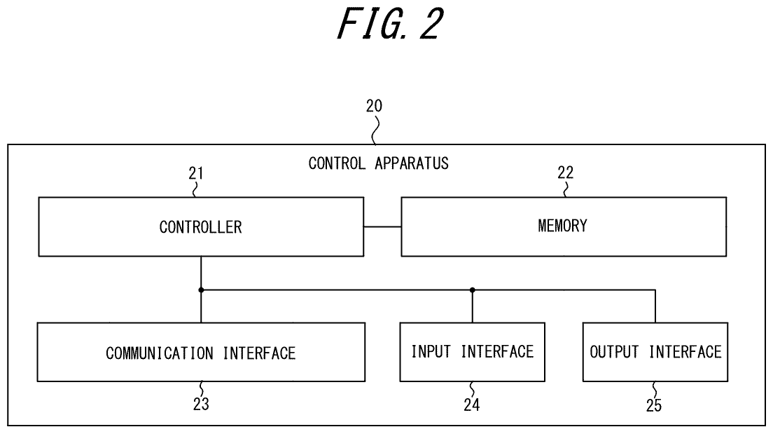

A configuration of the control apparatus 20 according to the present embodiment will be described with reference to FIG. 2.

The control apparatus 20 includes a controller 21, a memory 22, a communication interface 23, an input interface 24, and an output interface 25. The controller 21 includes at least one processor, at least one programmable circuit, at least one dedicated circuit, or a combination thereof. The processor is a general purpose processor such as a CPU or a GPU, or a dedicated processor that is dedicated to specific processing. The term “CPU” is an abbreviation of central processing unit. The term “GPU” is an abbreviation of graphics processing unit. The programmable circuit is, for example, an FPGA. The term “FPGA” is an abbreviation of field-programmable gate array. The dedicated circuit is, for example, an ASIC. The term “ASIC” is an abbreviation of application specific integrated circuit. The controller 21 executes processes related to operations of the control apparatus 20 while controlling components of the control apparatus 20.

The memory 22 includes at least one semiconductor memory, at least one magnetic memory, at least one optical memory, or a combination of at least two of these. The semiconductor memory is, for example, RAM or ROM. The term “RAM” is an abbreviation of random access memory. The term “ROM” is an abbreviation of read only memory. The RAM is, for example, SRAM or DRAM. The term “SRAM” is an abbreviation of static random access memory. The term “DRAM” is an abbreviation of dynamic random access memory. The ROM is, for example, EEPROM. The term “EEPROM” is an abbreviation of electrically erasable programmable read only memory. The memory 22 functions as, for example, a main memory, an auxiliary memory, or a cache memory. The memory 22 stores data to be used for the operations of the control apparatus 20 and data obtained by the operations of the control apparatus 20. Further, in the present embodiment, the memory 22 stores, when it has been determined to interrupt the control to be performed based on the first voice V1, the type of the function that was planned to be activated by the interrupted control and the attribute determined as the first attribute T1, with the type and the attribute being associated with each other. The memory 22 may also store position attribute information D1 indicating a correspondence relationship between the position of each seat in the vehicle 30 and an attribute of an occupant who is seated in that seat. In addition, the memory 22 may store voice attribute information D2 indicating a correspondence relationship between a feature of a voice of each occupant P and an attribute of that occupant.

The communication interface 23 includes at least one interface for communication. The interface for communication is, for example, a LAN interface. The communication interface 23 receives data to be used for the operations of the control apparatus 20, and transmits data obtained by the operations of the control apparatus 20. In the present embodiment, the communication interface 23 communicates with the vehicle 30.

The input interface 24 includes at least one interface for input. The interface for input is, for example, a physical key, a capacitive key, a pointing device, a touch screen integrally provided with a display, a voice sensor, or the like. The input interface 24 accepts an operation for inputting data to be used for the operations of the control apparatus 20. The input interface 24, instead of being included in the control apparatus 20, may be connected to the control apparatus 20 as an external input device. As the connection method, any technology such as USB, HDMI® (HDMI is a registered trademark in Japan, other countries, or both), or Bluetooth® (Bluetooth is a registered trademark in Japan, other countries, or both) can be used. The term “USB” is an abbreviation of Universal Serial Bus. The term “HDMI®” is an abbreviation of High-Definition Multimedia Interface. In the present embodiment, the input interface 24 is a voice sensor. The voice sensor is, for example, a microphone. The voice sensor is installed in each seat of the vehicle 30. The input interface 24 may also include an imaging device (camera) to be used for image analysis, as described below.

The output interface 25 includes at least one interface for output. The interface for output is, for example, a display or a speaker. The display is, for example, an LCD or an organic EL display. The term “LCD” is an abbreviation of liquid crystal display. The term “EL” is an abbreviation of electro luminescence. The output interface 25 outputs data obtained by the operations of the control apparatus 20. The output interface 25, instead of being included in the control apparatus 20, may be connected to the control apparatus 20 as an external output device. As the connection method, any technology such as USB, HDMI®, or Bluetooth® can be used.

The functions of the control apparatus 20 are realized by execution of a control program according to the present embodiment by a processor serving as the controller 21. That is, the functions of the control apparatus 20 are realized by software. The control program causes a computer to execute the operations of the control apparatus 20, thereby causing the computer to function as the control apparatus 20. That is, the computer executes the operations of the control apparatus 20 in accordance with the control program to thereby function as the control apparatus 20.

The program can be stored on a non-transitory computer readable medium. The non-transitory computer readable medium is, for example, flash memory, a magnetic recording device, an optical disc, a magneto-optical recording medium, or ROM. The program is distributed, for example, by selling, transferring, or lending a portable medium such as an SD card, a DVD, or a CD-ROM on which the program is stored. The term “SD” is an abbreviation of Secure Digital. The term “DVD” is an abbreviation of digital versatile disc. The term “CD-ROM” is an abbreviation of compact disc read only memory. The program may be distributed by storing the program in a storage of a server and transferring the program from the server to another computer. The program may be provided as a program product.

For example, the computer temporarily stores, in a main memory, a program stored in a portable medium or a program transferred from a server. Then, the computer reads the program stored in the main memory using a processor, and executes processes in accordance with the read program using the processor. The computer may read a program directly from the portable medium, and execute processes in accordance with the program. The computer may, each time a program is transferred from the server to the computer, sequentially execute processes in accordance with the received program. Instead of transferring a program from the server to the computer, processes may be executed by a so-called ASP type service that realizes functions only by execution instructions and result acquisitions. The term “ASP” is an abbreviation of application service provider. The program encompasses information that is to be used for processing by an electronic computer and is thus equivalent to a program. For example, data that is not a direct command to a computer but has a property that regulates processing of the computer is “equivalent to a program” in this context.

Some or all of the functions of the control apparatus 20 may be realized by a programmable circuit or a dedicated circuit serving as the controller 21. That is, some or all of the functions of the control apparatus 20 may be realized by hardware.

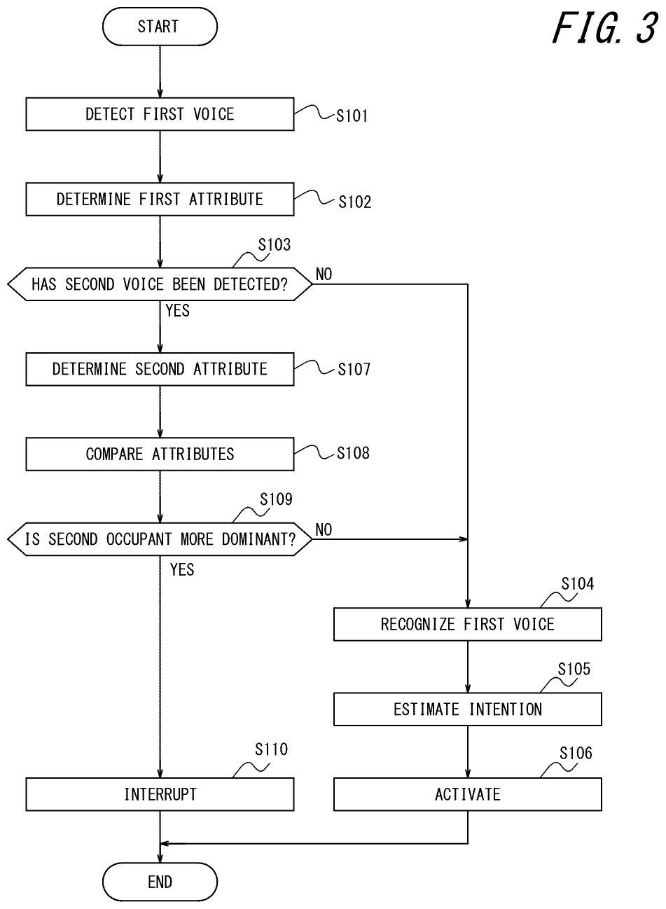

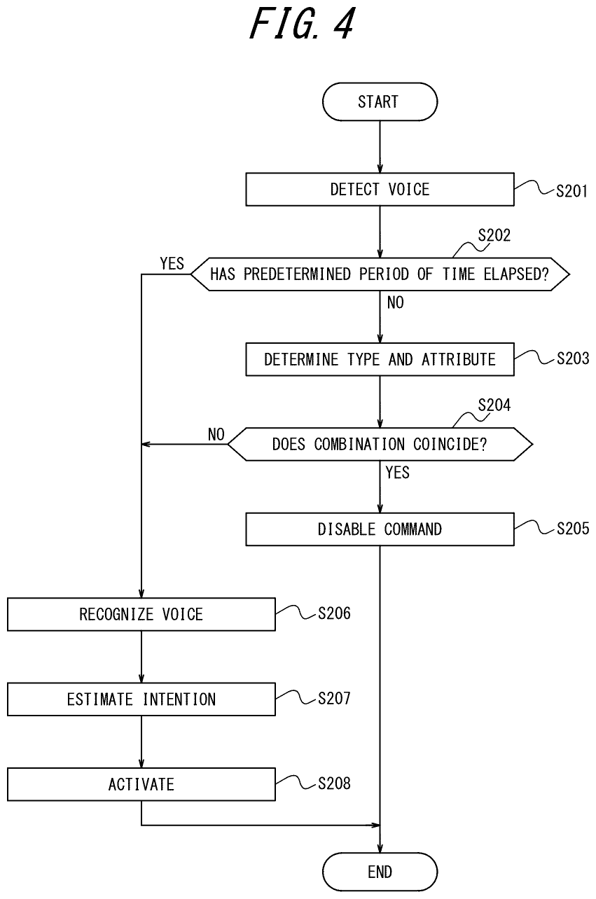

Operations of the system 10 according to the present embodiment will be described with reference to FIGS. 3 and 4. These operations correspond to a control method according to the present embodiment.

In S101 of FIG. 3 (each step of the flowchart is hereinafter identified by S and a number), the controller 21 of the control apparatus 20 detects the first voice V1 that has been uttered by the first occupant P1, among the plurality of occupants P. The first voice V1 is a voice that has been uttered as a command to activate the function f1 of the vehicle. The first voice V1 may be detected by any appropriate procedure, such as the following procedure. First, the voice sensor, as the input interface 24, collects the voice that has been uttered by the first occupant P1. The controller 21 analyzes the voice collected by the input interface 24 to determine whether the voice contains a predetermined activation word. When it is determined that the voice contains the activation word, the controller 21 detects, as the first voice V1, a voice that has been uttered by the first occupant P1 following the activation word.

In S102 of FIG. 3, the controller 21 of the control apparatus 20 determines, as the first attribute T1, the attribute of the first occupant P1 who has uttered the first voice V1. Specifically, the controller 21 determines the attribute of the first occupant P1 based on the position of a seat in which the first occupant P1 is seated. As an example, assume that voice sensors, as the input interface 24, are installed in individual seats of the vehicle 30, and that the memory 22 stores the position attribute information D1, which indicates the correspondence relationship between the position of each seat in the vehicle 30 and the attribute of the occupant who is seated in that seat. The correspondence relationship indicated by the position attribute information D1 is, for example, as follows. An attribute of “adult” corresponds to a seat position of a “driver's seat” or “front passenger's seat”. An attribute of “child” corresponds to a seat position of a “backseat on the driver's seat side” or “backseat on the passenger's seat side”. This position attribute information D1 can be set and registered when the occupants get on the vehicle 30. Upon detecting a voice V via one of the voice sensors as the input interface 24, the controller 21 identifies the position of a seat installed with the voice sensor that has detected the voice V. The controller 21 then determines, based on the identified position of the seat, an attribute of the occupant who has uttered the voice, with reference to the correspondence relationship indicated by the position attribute information D1 stored in the memory 22.

Assume that, under the above assumptions, the controller 21 of the control apparatus 20 identifies the position of a seat seated with the first occupant P1, as the “backseat on the passenger's seat side”. As a result, the controller 21 determines that the attribute of the first occupant P1 is “child”. Thus, the attributes of the occupants P can be simply determined based on the positions of the seats of the occupants P because the attribute of the occupant for each seat needs to be recognized only once at the beginning.

Instead of identifying the position of the seat seated with the first occupant P1, the controller 21 of the control apparatus 20 may determine the attribute of the first occupant P1, based on a feature of the first voice V1 that has been uttered by the first occupant P1. Specifically, the controller 21 acquires the voice attribute information D2, which indicates a correspondence relationship between a feature of a voice Vi of each occupant Pi and an attribute Ti of the occupant Pi. As an example, the voice attribute information D2, which indicates the correspondence relationship between the feature of the voice of each of the occupants P and the attribute T of that occupant P, is stored in the memory 22. Upon detecting the voice Vi that has been uttered by each occupant Pi, the controller 21 extracts the feature of the voice Vi by analyzing the voice Vi. The controller 21 determines, based on the extracted feature, the attribute Ti of the occupant Pi who has uttered the voice Vi, with reference to the correspondence relationship indicated by the voice attribute information D2. The correspondence relationship indicated by the voice attribute information D2 is, for example, as follows. An attribute of “adult” corresponds to a voice V with a frequency lower than a threshold. An attribute of “child” corresponds to a voice V with a frequency equal to or higher than the threshold. In this case, the controller 21 of the control apparatus 20 determines whether a frequency, which is extracted as the feature of the first voice V1 that has been uttered by the first occupant P1, is equal to or higher than the threshold. When it is determined that the frequency is equal to or higher than the threshold, the controller 21 determines that the attribute of the first occupant P1 is “child”. More specifically, a voice pattern of each occupant and an attribute of that occupant may be registered in advance, and the occupant Pi and the attribute Ti thereof may be determined by analyzing a voice pattern of the detected voice Vi. Thus, the attribute of the first occupant P1 can be determined based on the feature of the first voice V1 that has been uttered by the first occupant P1. In this manner, the attribute can be determined even when the seat position of the first occupant P1 has been changed.

The attribute may be determined by an occupant recognition apparatus, instead of by the controller 21 of the control apparatus 20, and the controller 21 may acquire the result of determination from the occupant recognition apparatus. The occupant recognition apparatus may be a separate apparatus independent of the control apparatus 20, or may be incorporated into the control apparatus 20. The occupant recognition apparatus may be, for example, an image analyzer, and may be equipped with an imaging device such as a camera. The occupant recognition apparatus may analyze an image captured by the imaging device, to thereby determine the attribute T of the occupant P who has uttered the voice.

In S103 of FIG. 3, the controller 21 of the control apparatus 20 determines whether the second voice V2 different from the first voice V1 is detected after the first voice V1 has been detected and before the function f1 is activated. The second voice V2 is the voice that has been uttered as a command to cancel the activation of the function f1. Any procedure may be used to determine whether the second voice V2 is detected. The following procedure, for example, may be used.

The controller 21 of the control apparatus 20 detects, among voices V detected after the first voice V1 has been detected and before the function f1 is activated, a voice that is different from the first voice V1 and contains a negative term, as the second voice V2, which has been uttered as a command to cancel the activation of the function f1. Examples of the “negative term” include terms such as “Don't do it”, “no”, and “stop”. Here, the reason for detecting the voice containing the negative term as the second voice V2 is as follows. As described above, in general, an occupant who wishes to perform voice operations activates a voice dialogue service called an agent by uttering an activation word, pressing a talk switch, or the like as a trigger, to start the voice operations. However, in the present embodiment, the voice containing the negative term can be directly detected as the second voice V2. Thus, the second occupant P2 can cancel the activation of the function f1 simply by uttering the negative term, without the trigger, such as the activation word or the talk switch. Thus, it is possible to promptly handle mischievous or erroneous operations.

In S103 of FIG. 3, the controller 21 determines that the second voice V2 has not been detected when, among the voices V detected after the first voice V1 has been detected and before the function f1 is activated, the voice that is different from the first voice V1 does not contain the negative term. When it is determined in S103 that the second voice V2 has not been detected, the processes from S104 to S106 are performed. The processes from S104 to S106 will be described later.

When it is determined that the second voice V2 has been detected in S103 of FIG. 3, the process of S107 is performed.

In S107 of FIG. 3, the controller 21 of the control apparatus 20 determines, as the second attribute T2, the attribute of the second occupant P2 who has uttered the second voice V2. A specific method for determining the second attribute T2 is the same as the method for determining the first attribute T1 in S102. Therefore, a description thereof is omitted.

In S108 of FIG. 3, the controller 21 of the control apparatus 20 compares the first attribute T1 determined in S102 with the second attribute T2 determined in S107. Specifically, the controller 21 estimates a dominance relationship R between the first occupant P1 and the second occupant P2 by comparing the first attribute T1 with the second attribute T2. The dominance relationship R is a relationship in which one is in a position to observe or direct and supervise the other. The controller 21 compares the first attribute T1 with the second attribute T2 to estimate which is dominant. The dominance relationship R includes a parent and child relationship, a teacher and student relationship, or a caregiver and patient relationship. For example, when estimating the parent and child relationship as the dominance relationship R, the controller 21 determines whether the attribute is “adult” or “child” in each of S102 and S107 and compares the attributes, to thereby estimate that “adult” is more dominant than “child” as the dominant relationship R. When estimating the teacher and student relationship as the dominant relationship R, the controller 21 determines whether the attribute is “student” or “teacher” in each of S102 and S107 and compares the attributes, to thereby estimate that “teacher” is more dominant than “student” as the dominant relationship R. Alternatively, when estimating the caregiver and patient relationship as the dominance relationship R, the controller 21 determines whether the attribute is “nurse” or “patient” in each of S102 and S107 and compares the attributes, to thereby estimate that “doctor or nurse” is more dominant than “patient” as the dominance relationship R.

In S109 of FIG. 3, the controller 21 of the control apparatus 20 estimates, as the dominance relationship R between the first occupant P1 and the second occupant P2, whether the second occupant P2 is more dominant than the first occupant P1, as a result of the comparison between the first occupant P1 and the second occupant P2. For example, when the parent and child relationship is estimated as the dominance relationship R in S108, the controller 21 estimates that an occupant P, whose attribute is “adult”, is more dominant than an occupant P, whose attribute is “child”. In S109, when it is estimated that there is no dominance or subordination between the first occupant P1 and the second occupant P2, or the first occupant P1 is more dominant than the second occupant P2, the controller 21 determines to continue control to be performed based on the first voice V1. Specifically, the processes from S104 to S106 are performed.

In S104 of FIG. 3, the controller 21 of the control apparatus 20 recognizes the first voice V1. Specifically, the controller 21 performs voice recognition on the first voice V1 detected in S101 to convert the first voice V1 into text.

In S105 of FIG. 3, the control apparatus 21 of the controller 20 estimates (interprets) the intention of the first voice V1 recognized in S104. For example, assume that the text transcribed in S104 is “Maximize wind of air conditioner”. The controller 21 estimates the intention of “to change the airflow rate of the air conditioning unit to maximum”, as the semantic interpretation for “Maximize wind of air conditioner”.

In S106 of FIG. 3, the controller 21 of the control apparatus 20 activates the function f1 of the vehicle 30 based on the intention interpreted in S105. For example, when the intention estimated in S105 is “to change the airflow rate of the air conditioning unit to maximum”, the controller 21 activates the function f1 of the vehicle 30 by controlling the airflow rate of the air conditioning unit installed in the vehicle 30 to maximum. In that case, prior to activating the function f1 of the vehicle 30, the controller 21 may output, through the output interface 25, a guidance informing a user that the function f1 is to be activated. For example, the controller 21 may create a message “Airflow of air conditioner is being maximized”, and control a speaker, as the output interface 25, to output the created message. Alternatively, the controller 21 may control a display, as the output interface 25, to display the created message.

On the other hand, when it is determined in S109 of FIG. 3 that the second occupant P2 is more dominant than the first occupant P1, the process of S110 is performed.

In S110 of FIG. 3, the controller 21 of the control apparatus 20 performs control to interrupt the control to be performed based on the first voice V1. Specifically, the controller 21 performs control to abort the activation of the function f1 controlled based on the first voice V1.

As described above, the control apparatus 20 detects, as commands, voices V that have been respectively uttered by the plurality of occupants P in the vehicle 30, and controls, based on the detected voices V, the functions F installed in the vehicle 30. The control apparatus 20 detects the first voice V1 that has been uttered by one of the occupants P as a command to activate the function f1. The control apparatus 20 determines, as the first attribute T1, the attribute of the first occupant P1 who has uttered the first voice V1. After the first voice V1 has been detected and before the function f1 is activated, the control apparatus 20 detects the second voice V2 that is different from the first voice V1 and has been uttered as a command to cancel the activation of the function f1. The control apparatus 20 determines, as the second attribute T2, the attribute of the second occupant P2 who has uttered the second voice V2. The control apparatus 20 compares the first attribute T1 with the second attribute T2, and determines, based on the result of the comparison, whether to interrupt the control to be performed based on the first voice V1.

According to the present embodiment, the control to be performed based on the first voice V1 can be interrupted by the second voice V2 when the predetermined condition is satisfied as the result of the comparison between the attributes T of the occupants P who have uttered the voices as commands. In other words, when a voice operation is performed based on speech of an occupant, another occupant can cancel the voice operation as necessary. As a result, unintended operations such as mischievous or erroneous operations can be restricted.

In the flowchart of the present embodiment, after the attribute of the first occupant P1 who has uttered the first voice V1 is determined as the first attribute T1 in S102, the second voice detection in S103 or the comparison between the first attribute T1 and the second attribute T2 in S109 is performed. However, a step of determining the dominance of the first attribute T1 may be further added immediately after S102. When the first attribute T1 is the most dominant attribute in the dominance relationship R, the operation may immediately proceed to S104 without performing the step of S103. When the first attribute T1 is not the most dominant attribute in the dominance relationship R, the operation may proceed to S103. This allows the processes of S103 and S107 to S110 to be omitted when the first attribute T1 is the dominant attribute (e.g., adult).

As a variation of the present embodiment, the controller 21 of the control apparatus 20 may, after the control to be performed based on the first voice V1 is interrupted in S110 of FIG. 3, store, in the memory 22, the type of the function f1 that was planned to be activated by the interrupted control by associating the type with the attribute determined as the first attribute T1. For example, when the first attribute T1 determined in S102 is “child” and the type of the function f1 interrupted in S110 is “air conditioning unit”, the controller 21 stores, in the memory 22, “air conditioning unit”, as the type of the function f1, and “child”, as the attribute, by associating the “air conditioning unit” with “child”. Upon detecting, as commands, voices V that have been uttered by the individual occupants P before a predetermined period of time elapses since the control to be performed based on the first voice V1 has been interrupted, the controller 21 determines, for each of the detected voices V, the type of a function fi to be activated by control to be performed based on a voice Vi and an attribute Ti of an occupant Pi who has uttered the voice Vi. The controller 21 then determines whether a combination of the determined type of the function fi and the determined attribute Ti coincides with any of the combinations of the type of the function f and the attribute T, which are stored in correspondence with each other in the memory 22. For example, when it is determined that the type of the function fi is “air conditioning unit” and the attribute Ti is “child”, as the result of determination of the type of the function fi to be activated by the control to be performed based on the voice Vi and the attribute Ti of the occupant Pi who has uttered the voice Vi, the controller 21 may determine that the combination of the type of function fi and the attribute Ti coincides with any of the combinations of the type of the function f and the attribute T, which are stored as being associated with each other in the memory 22, and disable a command by the voice Vi. In other words, the controller 21 may control the “air conditioning unit” in the vehicle 30 not to activate. Specifically, the following processes S201 to S205 may be further performed.

In S201 of FIG. 4, the controller 21 of the control apparatus 20 detects, as commands, the voices V that have been uttered by the individual occupants P. Specifically, the voice sensor, as the input interface 24, collects the voice Vi that has been uttered by the occupant Pi. The controller 21 analyzes the voice Vi collected by the input interface 24, to determine whether the voice Vi contains a predetermined activation word. When it is determined that the voice Vi contains the activation word, the controller 21 detects, as a command, a voice that has been uttered by the occupant Pi following the activation word.

In S202 of FIG. 4, the controller 21 of the control apparatus 20 determines whether the predetermined period of time has elapsed since the control to be performed based on the first voice V1 has been interrupted in S110 of FIG. 3. The predetermined period of time can be arbitrarily set for a desired period of time, for example, several minutes, several hours, or until an engine of the vehicle 30 turns off, during which the same operation as the interrupted operation is prohibited from being repeated by speech by an occupant of the same attribute. When it is determined in S202 that the predetermined period of time has not elapsed, the process of S203 is performed. On the other hand, when it is determined in S202 that the predetermined period of time has elapsed, the control to be performed based on voice Vi is continued. Specifically, the processes from S206 to S208 are performed. The processes from S206 to S208 will be described later.

In S203 of FIG. 4, the controller 21 of the control apparatus 20 determines, for each of the voices V detected in S201, the type of function fi to be activated by the control to be performed based on each voice Vi and the attribute Ti of the occupant Pi who has uttered that voice Vi. For example, assume that the controller 21 determines that the type of function fi is “air conditioning unit” and the attribute Ti is “child”.

In S204 of FIG. 4, the controller 21 of the control apparatus 20 determines whether the combination of the determined type of the function fi and the determined attribute Ti coincides with any of the combinations of the type of the function f1 and the attribute T1, which are stored as being associated with each other in the memory 22. As an example, assume that since the first attribute T1 is “child” and the type of the interrupted function f1 is “air conditioning unit” in S110, “air conditioning unit”, as the type of the function f1, and “child”, as the attribute, are stored as being associated with each other in the memory 22. At this time, when the type of the function fi is “air conditioning unit” and the attribute Ti is “child” in S203, the controller 21 determines that the combination of the determined type of the function fi and the determined attribute Ti coincides with any of the combinations of the type of the function f1 and the attribute T1, which are stored as being associated with each other in the memory 22. When it is determined that the combinations coincide with each other in S204, the process of S205 is performed.

In S205 of FIG. 4, the controller 21 of the control apparatus 20 disables the command by the voice Vi. Specifically, the controller 21 controls the function fi not to be activated.

On the other hand, when it is determined that the combinations do not coincide with each other in S204 of FIG. 4, the controller 21 continues the control to be performed based on the voice Vi. Specifically, the processes from S206 to S208 of FIG. 4 are performed. The processes from S206 to S208 are similar to the processes from S104 to S106 of FIG. 3, except that the voice Vi is recognized instead of recognizing the first voice V1 in the processes from S104 to S106 of FIG. 3. Therefore, a description thereof is omitted.

As described above, when it is determined to interrupt the control to be performed based on the first voice V1, the control apparatus 20 stores the type of the function f1 that was planned to be activated by the interrupted control and the attribute T1 determined as the first attribute T1 as being associated with each other. Upon detecting, as commands, the voices V that have been uttered by the individual occupants P before the predetermined period of time elapses since the control to be performed based on the first voice V1 has been interrupted, the control apparatus 20 determines, for each of the detected voices V, the type of the function fi to be activated by the control to be performed based on the voice Vi and the attribute Ti of the occupant Pi who has uttered the voice Vi. The control apparatus 20 then determines whether the combination of the type of the determined function fi and the determined attribute Ti coincides with any of the combinations of the type of the function and the attribute stored in advance as being associated with each other. When it is determined that the combinations coincide with each other, the control apparatus 20 disables the command to be performed based on the voice Vi.

According to this variation, when the first occupant P1 alone or an occupant Pi whose attribute is the same as that of the first occupant P1 repeats the same speech many times in a mischievous manner within the certain period of time, the operation can be automatically disabled without waiting for speech of the second occupant P2. Therefore, unintended operations such as mischievous or erroneous operations can be restricted more reliably.

The present disclosure is not limited to the embodiment described above. For example, a plurality of blocks described in the block diagram may be integrated, or a block may be divided. Instead of executing a plurality of steps described in the flowchart in chronological order in accordance with the description, the plurality of steps may be executed in parallel or in a different order according to the processing capability of the apparatus that executes each step, or as required. Other modifications can be made without departing from the spirit of the present disclosure.

Examples of some embodiments of the present disclosure are described below. However, it should be noted that the embodiments of the present disclosure are not limited to these examples.

[Appendix 1] A control apparatus configured to detect, as a command, a voice having been uttered by each of a plurality of occupants in a vehicle, and control, based on the detected voice, a function installed in the vehicle, the control apparatus comprising:
a controller configured to:
   upon detecting a first voice having been uttered by a first occupant, among the plurality of occupants, the first voice having been uttered as a command to activate the function, determine, as a first attribute, an attribute of the first occupant;
   upon detecting, after the first voice has been detected and before the function is activated, a second voice different from the first voice, the second voice having been uttered as a command to cancel the activation of the function, determine, as a second attribute, an attribute of a second occupant who has uttered the second voice; and
   determine, according to a result of a comparison between the first attribute and the second attribute, whether to interrupt control to be performed based on the first voice.
      [Appendix 2] The control apparatus according to appendix 1, wherein
the vehicle has voice sensors installed in individual seats thereof,
the controller is configured to acquire position attribute information indicating a correspondence relationship between a position of each seat and an attribute of an occupant who is seated in that seat, and
upon detecting a voice via one of the voice sensors, the controller is configured to identify a position of a seat installed with the voice sensor that has detected the voice, and determine, based on the identified position of the seat, an attribute of an occupant who has uttered the voice, with reference to the correspondence relationship indicated by the position attribute information.
   [Appendix 3] The control apparatus according to appendix 1 or 2, wherein
the controller is configured to acquire voice attribute information indicating a correspondence relationship between a feature of a voice of each occupant and an attribute of that occupant, and
upon detecting a voice having been uttered by each of the occupants, the controller is configured to extract a feature of the voice by analyzing the voice, and determine, based on the extracted feature, an attribute of the occupant who has uttered the voice, with reference to the correspondence relationship indicated by the voice attribute information.
   [Appendix 4] The control apparatus according to any one of appendices 1 to 3, wherein the controller is configured to detect, among voices detected after the first voice has been detected and before the function is activated, a voice different from the first voice, the voice containing a negative term, as the second voice having been uttered as a command to cancel the activation of the function.
   [Appendix 5] The control apparatus according to any one of appendices 1 to 4, wherein the controller is configured to compare the first attribute with the second attribute, to thereby estimate a dominance relationship between the first occupant and the second occupant.
   [Appendix 6] The control apparatus according to any one of appendices 1 to 5, wherein when it is estimated that there is no dominance or subordination between the first occupant and the second occupant, or the first occupant is more dominant than the second occupant, the controller is configured to determine to continue the control to be performed based on the first voice.
   [Appendix 7] The control apparatus according to any one of appendices 1 to 6, wherein when it is estimated that the second occupant is more dominant than the first occupant, the controller is configured to determine to interrupt the control to be performed based on the first voice.
   [Appendix 8] The control apparatus according to any one of appendices 1 to 7, wherein the controller is configured to estimate, as a dominance relationship, a parent and child relationship, a teacher and student relationship, or a caregiver and patient relationship.
   [Appendix 9] The control apparatus according to any one of appendices 1 to 8, further comprising:
a memory configured to store, when the controller has determined, according to the result of comparing the first attribute with the second attribute, to interrupt the control to be performed based on the first voice, a type of the function that was planned to be activated by the interrupted control and the attribute determined as the first attribute by associating the type with the attribute,
wherein the controller is configured to:
   upon detecting, as commands, voices having been uttered by the individual occupants before a predetermined period of time elapses since the control to be performed based on the first voice has been interrupted, determine, for each of the detected voices, a type of a function to be activated by control to be performed based on each voice and an attribute of an occupant who has uttered that voice;
   determine, with reference to the memory, whether a combination of the determined type of the function and the determined attribute coincides with a combination of the type of the function and the attribute stored as being associated with each other in the memory; and
   disable a command by that voice when the combinations are determined to coincide with each other.
      [Appendix 10] A vehicle comprising the control apparatus according to any one of appendices 1 to 9.
      [Appendix 11] A control method performed by a control apparatus configured to detect, as a command, a voice having been uttered by each of a plurality of occupants in a vehicle, and control, based on the detected voice, a function installed in the vehicle, the control method comprising:
detecting, by the control apparatus, a first voice having been uttered by a first occupant, among the plurality of occupants, the first voice having been uttered as a command to activate the function;
determining, by the control apparatus, as a first attribute, an attribute of the first occupant;
detecting, by the control apparatus, after the first voice has been detected and before the function is activated, a second voice different from the first voice, the second voice having been uttered as a command to cancel the activation of the function;
determining, by the control apparatus, as a second attribute, an attribute of a second occupant who has uttered the second voice;
comparing, by the control apparatus, the first attribute with the second attribute; and
determining, by the control apparatus, according to a result of the comparison, whether to interrupt control to be performed based on the first voice.
   [Appendix 12] The control method according to appendix 11, wherein
the vehicle has voice sensors installed in individual seats thereof,
the control method further comprises acquiring position attribute information indicating a correspondence relationship between a position of each seat and an attribute of an occupant who is seated in that seat, and
the determining of the attribute includes, upon detecting a voice via one of the voice sensors, identifying a position of a seat installed with the voice sensor that has detected the voice, and determining, based on the identified position of the seat, an attribute of an occupant who has uttered the voice, with reference to the correspondence relationship indicated by the position attribute information.
   [Appendix 13] The control method according to appendix 11 or 12, further comprising:
acquiring, by the control apparatus, voice attribute information indicating a correspondence relationship between a feature of a voice of each occupant and an attribute of that occupant,
wherein the determining of the attribute includes, upon detecting a voice having been uttered by each of the occupants, extracting a feature of the voice by analyzing the voice, and determining, based on the extracted feature, an attribute of the occupant who has uttered the voice, with reference to the correspondence relationship indicated by the voice attribute information.
   [Appendix 14] The control method according to any one of appendices 11 to 13, wherein the detecting of the second voice includes detecting, among voices detected after the first voice has been detected and before the function is activated, a voice different from the first voice, the voice containing a negative term, as the second voice having been uttered as a command to cancel the activation of the function.
   [Appendix 15] The control method according to any one of appendices 11 to 14, wherein the comparing of the first attribute with the second attribute includes estimating a dominance relationship between the first occupant and the second occupant.
   [Appendix 16] A program configured to cause a computer, as a control apparatus, to execute operations, the control apparatus being configured to detect, as a command, a voice having been uttered by each of a plurality of occupants in a vehicle, and control, based on the detected voice, a function installed in the vehicle, the operations comprising:
detecting a first voice having been uttered by a first occupant, among the plurality of occupants, the first voice having been uttered as a command to activate the function;
determining, as a first attribute, an attribute of the first occupant;
upon detecting, after the first voice has been detected and before the function is activated, a second voice different from the first voice, the second voice having been uttered as a command to cancel the activation of the function, determining, as a second attribute, an attribute of a second occupant who has uttered the second voice;
comparing the first attribute with the second attribute; and
determining, according to a result of the comparison, whether to interrupt control to be performed based on the first voice.
   [Appendix 17] The program according to appendix 16, wherein
the vehicle has voice sensors installed in individual seats thereof,
the operations further comprise acquiring position attribute information indicating a correspondence relationship between a position of each seat and an attribute of an occupant who is seated in that seat, and
the determining of the attribute includes, upon detecting a voice via one of the voice sensors, identifying a position of a seat installed with the voice sensor that has detected the voice, and determining, based on the identified position of the seat, an attribute of an occupant who has uttered the voice, with reference to the correspondence relationship indicated by the position attribute information.
   [Appendix 18] The program according to appendix 16 or 17, wherein
the operations further comprise acquiring voice attribute information indicating a correspondence relationship between a feature of a voice of each occupant and an attribute of the occupant, and
the determining of the attribute includes, upon detecting a voice having been uttered by each of the occupants, extracting a feature of the voice by analyzing the voice, and determining, based on the extracted feature, an attribute of the occupant who has uttered the voice, with reference to the correspondence relationship indicated by the voice attribute information.
   [Appendix 19] The program according to any one of appendices 16 to 18, wherein the detecting of the second voice includes detecting, among voices detected after the first voice has been detected and before the function is activated, a voice different from the first voice, the voice containing a negative term, as the second voice having been uttered as a command to cancel the activation of the function.
   [Appendix 20] The program according to any one of appendices 16 to 19, wherein the comparing of the first attribute with the second attribute includes estimating a dominance relationship between the first occupant and the second occupant.

1. A control apparatus configured to detect, as a command, a voice having been uttered by each of a plurality of occupants in a vehicle, and control, based on the detected voice, a function installed in the vehicle, the control apparatus comprising:
a controller configured to:
upon detecting a first voice having been uttered by a first occupant, among the plurality of occupants, the first voice having been uttered as a command to activate the function, determine, as a first attribute, an attribute of the first occupant;
upon detecting, after the first voice has been detected and before the function is activated, a second voice different from the first voice, the second voice having been uttered as a command to cancel the activation of the function, determine, as a second attribute, an attribute of a second occupant who has uttered the second voice; and
determine, according to a result of a comparison between the first attribute and the second attribute, whether to interrupt control to be performed based on the first voice.

2. The control apparatus according to claim 1, wherein
the vehicle has voice sensors installed in individual seats thereof,
the controller is configured to acquire position attribute information indicating a correspondence relationship between a position of each seat and an attribute of an occupant who is seated in that seat, and
upon detecting a voice via one of the voice sensors, the controller is configured to identify a position of a seat installed with the voice sensor that has detected the voice, and determine, based on the identified position of the seat, an attribute of an occupant who has uttered the voice, with reference to the correspondence relationship indicated by the position attribute information.

3. The control apparatus according to claim 1, wherein
the controller is configured to acquire voice attribute information indicating a correspondence relationship between a feature of a voice of each occupant and an attribute of that occupant, and
upon detecting a voice having been uttered by each of the occupants, the controller is configured to extract a feature of the voice by analyzing the voice, and determine, based on the extracted feature, an attribute of the occupant who has uttered the voice, with reference to the correspondence relationship indicated by the voice attribute information.

4. The control apparatus according to claim 1, wherein the controller is configured to detect, among voices detected after the first voice has been detected and before the function is activated, a voice different from the first voice, the voice containing a negative term, as the second voice having been uttered as a command to cancel the activation of the function.

5. The control apparatus according to claim 1, wherein the controller is configured to compare the first attribute with the second attribute, to thereby estimate a dominance relationship between the first occupant and the second occupant.

6. The control apparatus according to claim 5, wherein when it is estimated that there is no dominance or subordination between the first occupant and the second occupant, or the first occupant is more dominant than the second occupant, the controller is configured to determine to continue the control to be performed based on the first voice.

7. The control apparatus according to claim 5, wherein when it is estimated that the second occupant is more dominant than the first occupant, the controller is configured to determine to interrupt the control to be performed based on the first voice.

8. The control apparatus according to claim 5, wherein the controller is configured to estimate, as the dominance relationship, a parent and child relationship, a teacher and student relationship, or a caregiver and patient relationship.

9. The control apparatus according to claim 5, further comprising:
a memory configured to store, when the controller has determined, according to the result of comparing the first attribute with the second attribute, to interrupt the control to be performed based on the first voice, a type of the function that was planned to be activated by the interrupted control and the attribute determined as the first attribute, by associating the type with the attribute,
wherein the controller is configured to:
upon detecting, as commands, voices having been uttered by the individual occupants before a predetermined period of time elapses since the control to be performed based on the first voice has been interrupted, determine, for each of the detected voices, a type of a function to be activated by control to be performed based on each voice and an attribute of an occupant who has uttered that voice;
determine, with reference to the memory, whether a combination of the determined type of the function and the determined attribute coincides with a combination of the type of the function and the attribute stored as being associated with each other in the memory; and
disable a command by that voice when the combinations are determined to coincide with each other.

10. A vehicle comprising the control apparatus according to claim 1.

11. A control method performed by a control apparatus configured to detect, as a command, a voice having been uttered by each of a plurality of occupants in a vehicle, and control, based on the detected voice, a function installed in the vehicle, the control method comprising:
detecting, by the control apparatus, a first voice having been uttered by a first occupant, among the plurality of occupants, the first voice having been uttered as a command to activate the function;
determining, by the control apparatus, as a first attribute, an attribute of the first occupant;
detecting, by the control apparatus, after the first voice has been detected and before the function is activated, a second voice different from the first voice, the second voice having been uttered as a command to cancel the activation of the function;
determining, by the control apparatus, as a second attribute, an attribute of a second occupant who has uttered the second voice;
comparing, by the control apparatus, the first attribute with the second attribute; and
determining, by the control apparatus, according to a result of the comparison, whether to interrupt control to be performed based on the first voice.

12. The control method according to claim 11, wherein
the vehicle has voice sensors installed in individual seats thereof,
the control method further comprises acquiring position attribute information indicating a correspondence relationship between a position of each seat and an attribute of an occupant who is seated in that seat, and
the determining of the attribute includes, upon detecting a voice via one of the voice sensors, identifying a position of a seat installed with the voice sensor that has detected the voice, and determining, based on the identified position of the seat, an attribute of an occupant who has uttered the voice, with reference to the correspondence relationship indicated by the position attribute information.

13. The control method according to claim 11, further comprising:
acquiring, by the control apparatus, voice attribute information indicating a correspondence relationship between a feature of a voice of each occupant and an attribute of that occupant,
wherein the determining of the attribute includes, upon detecting a voice having been uttered by each of the occupants, extracting a feature of the voice by analyzing the voice, and determining, based on the extracted feature, an attribute of the occupant who has uttered the voice, with reference to the correspondence relationship indicated by the voice attribute information.

14. The control method according to claim 11, wherein the detecting of the second voice includes detecting, among voices detected after the first voice has been detected and before the function is activated, a voice different from the first voice, the voice containing a negative term, as the second voice having been uttered as a command to cancel the activation of the function.

15. The control method according to claim 11, wherein the comparing of the first attribute with the second attribute includes estimating a dominance relationship between the first occupant and the second occupant.

16. A non-transitory computer readable medium storing a program configured to cause a computer, as a control apparatus, to execute operations, the control apparatus being configured to detect, as a command, a voice having been uttered by each of a plurality of occupants in a vehicle, and control, based on the detected voice, a function installed in the vehicle, the operations comprising:
detecting a first voice having been uttered by a first occupant, among the plurality of occupants, the first voice having been uttered as a command to activate the function;
determining, as a first attribute, an attribute of the first occupant;
upon detecting, after the first voice has been detected and before the function is activated, a second voice different from the first voice, the second voice having been uttered as a command to cancel the activation of the function, determining, as a second attribute, an attribute of a second occupant who has uttered the second voice;
comparing the first attribute with the second attribute; and
determining, according to a result of the comparison, whether to interrupt control to be performed based on the first voice.

17. The non-transitory computer readable medium according to claim 16, wherein
the vehicle has voice sensors installed in individual seats thereof,
the operations further comprise acquiring position attribute information indicating a correspondence relationship between a position of each seat and an attribute of an occupant who is seated in that seat, and
the determining of the attribute includes, upon detecting a voice via one of the voice sensors, identifying a position of a seat installed with the voice sensor that has detected the voice, and determining, based on the identified position of the seat, an attribute of an occupant who has uttered the voice, with reference to the correspondence relationship indicated by the position attribute information.

18. The non-transitory computer readable medium according to claim 16, wherein
the operations further comprise acquiring voice attribute information indicating a correspondence relationship between a feature of a voice of each occupant and an attribute of the occupant, and
the determining of the attribute includes, upon detecting a voice having been uttered by each of the occupants, extracting a feature of the voice by analyzing the voice, and determining, based on the extracted feature, an attribute of the occupant who has uttered the voice, with reference to the correspondence relationship indicated by the voice attribute information.

19. The non-transitory computer readable medium according to claim 16, wherein the detecting of the second voice includes detecting, among voices detected after the first voice has been detected and before the function is activated, a voice different from the first voice, the voice containing a negative term, as the second voice having been uttered as a command to cancel the activation of the function.

20. The non-transitory computer readable medium according to claim 16, wherein the comparing of the first attribute with the second attribute includes estimating a dominance relationship between the first occupant and the second occupant.
